(19) United States
(12) Patent Application Publication
(10) Pub. No.: US 2012/0297606 A1
(43) Pub. Date: Nov. 29, 2012

(54) METHOD AND APPARATUS FOR INVERTING A VEHICLE ASSEMBLY

(75) Inventors: Richard L. Winter, JR., Summerville, SC (US); G. Wesley Blankenship, Saline, MI (US)

(73) Assignee: FORCE PROTECTION TECHNOLOGIES, INC.

(21) Appl. No.: 13/307,300

(22) Filed: Nov. 30, 2011

Related U.S. Application Data
(62) Division of application No. 12/068,928, filed on Feb. 13, 2008, now abandoned.

(51) Int. Cl. B23P 11/00

(52) U.S. Cl. 29/430

(57) ABSTRACT

A method of inverting a vehicle assembly includes initially supporting the vehicle assembly with a first frame element relative to a surface, and positioning the first frame element and the vehicle assembly relative a second frame element, such that at least a portion of the vehicle assembly is disposed between the first and second frame elements. The method also includes selectively engaging at least one turning apparatus with the first frame element, and rotating the first frame element, the vehicle assembly, and the second frame element about a longitudinal axis extending through the vehicle assembly via the at least one turning apparatus from a first position to a second position. The method also includes selectively disengaging the at least one turning apparatus from the second frame element and subsequently supporting the vehicle assembly with the second frame element relative to the surface.

### FIELD OF THE INVENTION

The present invention relates to a method and apparatus for inverting a vehicle assembly and, in particular, to a apparatus for inverting a vehicle assembly, a method of inverting a vehicle assembly, and a method of assembling a vehicle.

### BACKGROUND

Conventional vehicles are usually assembled via a manufacturing process including various stations. Typically, various components are assembled or arranged relative to one another at a given station of the manufacturing process to form a partially assembled vehicle. As the partially formed vehicle moves to successive stations, additional components are assembled or arranged relative to one another and/or to the partially assembled vehicle automatically, e.g., by programmed robotic manipulators, and/or manually, e.g., by laborers. As the partially assembled vehicle progresses through the stations, a fully assembled vehicle may be established.

Generally, in an effort to increase efficiency in manufacturing vehicles that include numerous individual components, sub-assemblies are typically assembled via one or more separate manufacturing processes. Often these sub-assemblies are formed from various individual components ranging in size from relatively small components, which may be relatively easy to handle, to relatively large components, which may require substantial precautions and/or expertise to handle. Assembling individual components into sub-assemblies and subsequently assembling the sub-assemblies to form a partial vehicle may compound the difficulty in handling relatively large components and assembling a vehicle. Often, the orientation of the partially assembled vehicle and the sub-assembly as well as the attachment or connection method and/or position further compounds the difficulty in assembling a vehicle.

For example, drive trains, traction devices, and/or components thereof may be relatively large and may, for example, weigh several hundred pounds. Such components require cranes or other machinery to assist laborers in positioning them relative to, for example, a partially formed vehicle chassis. Because these components are attached to the undercarriage of the vehicle chassis, complex rigging may be necessary to position and attach these components underneath an upright vehicle chassis. Such an attachment may be relatively time consuming, difficult, costly, and unsafe. Alternatively, the vehicle chassis may be partially assembled in an inverted position permitting these components to be positioned and attached on top of the inverted vehicle chassis, potentially reducing the complexity of the rigging. Such an attachment may be relatively less time consuming, easier, less costly, and safer; however, the inverted vehicle chassis must be rotated to its upright position at a later station of the manufacturing process.

As the partially assembled vehicle itself increases in size during successive stations of the manufacturing process, the problems associated with assembling the vehicle in an upright or inverted position may increase the complexity of manufacturing the vehicle. Additionally, these problems may yet be further compounded as the tare weight of the vehicle is increased and as the individual components and the sub-assemblies increase in size.

Accommodating such relatively large components, sub-assemblies, and vehicles, by using conventional cranes and/or by taking significant safety precautions, is in tension with the ability to timely manufacture such vehicles. Thus, there exists a need for an improved method and apparatus for assembling vehicles, especially vehicles having relatively large tare weigh, relatively large components, and/or relative large sub-assemblies. The present disclosure is directed to overcoming one or more of the shortcomings noted above.

### SUMMARY

An aspect of the present disclosure is directed to an apparatus for inverting a vehicle assembly. The apparatus includes a first frame element configured to engage at least a portion of a first side of the vehicle assembly. The first side extends along a longitudinal direction of the vehicle assembly. The apparatus also includes a second frame element configured to engage at least a portion of a second side of the vehicle assembly. The second side extends along a longitudinal direction of the vehicle assembly and is substantially opposite the first side. The apparatus also includes a first turning apparatus configured to selectively engage the first and second frame elements at respective first ends thereof. The apparatus further includes a second turning apparatus configured to selectively engage the first and second frame elements at respective second ends thereof. The second ends are substantially opposite the first ends. The first and second turning apparatus are further configured to rotate the vehicle apparatus, the first frame element, and the second frame element about an axis.

Another aspect of the present disclosure is directed to an apparatus for inverting equipment within a spatial envelope. The apparatus includes a first frame element configured to define a first side of the envelope and a second frame element configured to define a second side of the envelope. The second side is substantially opposite the first side. The first and second turning elements are each configured to selectively engage the first and second frame elements at respective first and second ends thereof and rotate the first frame and second frame elements together about an axis. The axis extends between the first and second frame elements and through the envelope along a longitudinal dimension of the envelope.

Another aspect of the present disclosure is directed to a method of inverting a vehicle assembly. The method includes initially supporting the vehicle assembly with a first frame element relative to a surface. The method also includes positioning the first frame element and the vehicle assembly relative to a second frame element, such that at least a portion of the vehicle assembly is disposed between the first and second frame elements. The method also includes selectively engaging at least one turning apparatus with the first frame element. The method also includes rotating the first frame element, the vehicle assembly, and the second frame element about a longitudinal axis extending through the vehicle assembly via the at least one turning apparatus from a first position to a second position. The first frame element is disposed between the surface and the vehicle assembly in the first position and the second frame element is disposed between the surface and the vehicle assembly in the second position. The method further includes selectively disengaging the at least one turning apparatus from the second frame element and subsequently supporting the vehicle assembly with the second frame element relative to the surface.

Yet another aspect of the present disclosure is directed to a method of assembling a vehicle. The method includes partially assembling the vehicle at a first station of a manufacturing process and transporting the partially assembled vehicle from the first station to a second station of the manufacturing process on a first frame member. The first frame member is configured to support the partially assembled vehicle with respect to the ground. The method also includes supporting the partially assembled vehicle at the second station via the first frame member and via a second frame member. The method also includes rotating the partially assembled vehicle, the first frame member, and the second frame member about an axis that passes through the partially assembled vehicle. The method further includes transporting the partially assembled vehicle from the second station to a third station of the manufacturing process on the second frame member. The second frame member is configured to support the partially assembled vehicle with respect to the ground.

### BRIEF DESCRIPTION OF THE DRAWINGS

FIG. 1 is a diagrammatic illustration of a vehicle manufacturing process in accordance with an embodiment of the present disclosure;

FIG. 2 is a diagrammatic illustration of an inverting apparatus in a given arrangement in accordance with an embodiment of the present disclosure;

FIG. 3 is a diagrammatic illustration of an inverting apparatus in another given arrangement in accordance with an embodiment of the present disclosure;

FIG. 4 is a diagrammatic illustration of an inverting apparatus in another given arrangement in accordance with an embodiment of the present disclosure;

FIG. 5 is a diagrammatic illustration of an inverting apparatus in another given arrangement in accordance with an embodiment of the present disclosure;

FIG. 6 is a diagrammatic illustration of an inverting apparatus in another given arrangement in accordance with an embodiment of the present disclosure;

FIG. 7 is a diagrammatic illustration of an inverting apparatus in yet another given arrangement in accordance with an embodiment of the present disclosure; and

FIG. 8 is a flow chart diagram of an exemplary method of inverting a vehicle apparatus in accordance with an embodiment of the present disclosure.

### DETAILED DESCRIPTION

Reference will now be made in detail to the present preferred embodiments of the disclosure, examples of which are illustrated in the accompanying drawings.

In accordance with the disclosure, there is provided a vehicle manufacturing process 10 including a plurality of stations 12. Process 10 may be configured to receive a plurality of components of a vehicle, manipulate the plurality of components, and assembly a vehicle. Stations 12 may include any equipment and/or operation configured to affect a manipulation with respect to assembling a vehicle. Stations 12 may be configured to receive a partially assembled vehicle from a previous station, perform some type of manipulation thereto to alter the partially assembled vehicle from a less desirable configuration to a more desirable configuration, and direct the manipulated partially assembled vehicle to a subsequent station. Resources may be allocated with respect to stations 12 and may be utilized and/or consumed to achieve the manipulations performed within stations 12. For example, the resources may include machinery, e.g., robots, tooling, cranes or support elements; labor, e.g., manual labor or mechanized labor; utilities, e.g., electricity or fuel; raw materials; and/or other apparatus or consumables configured to be affiliated with and/or utilized by stations 12 to perform various manipulations throughout process 10. It is contemplated that process 10 may include any number of stations, each configured to perform any type of manipulation, and is described herein as including three stations for explanative purposes only.

Specifically, stations 12 may include a first assembling station 14, an inverting station 16, and a second assembling station 18. First assembling station 14 may be configured to receive a partially assembled vehicle from a previous station (not shown) and may include attaching and/or assembling one or more subcomponents together to form a partially assembled vehicle oriented in an inverted position 20, hereinafter referred to as inverted vehicle assembly 20. Station 14 may establish at least a portion of inverted vehicle assembly 20 and may include welding, bolting, snap-fitting, arranging, and/or any other assembling task known in the art. Station 14 may also include initially pre-assembling one or more subcomponents and subsequently connecting the preassembled subcomponents onto inverted vehicle assembly 20. Station 14 may or may not be configured as the first station of manufacturing process 10.

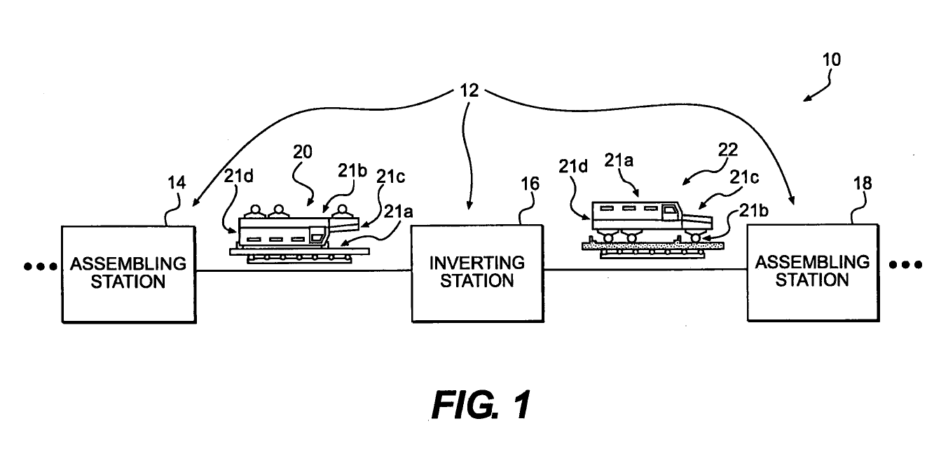

Inverted vehicle assembly 20 may include a chassis portion having first side 21a thereof configured to be at least a portion of the roof of a fully assembled vehicle (not shown) and a second side 21b thereof, substantially opposite the first side, configured to be at least a portion of the undercarriage of a fully assembled vehicle (not shown). Inverted vehicle assembly 20 may be supported with respect to a surface, such as the ground, on first side 21a, e.g., the roof, such that the roof is configured as the “bottom” of inverted vehicle assembly 20 and second side 21b, e.g., the undercarriage, is configured as the “top” of inverted vehicle assembly 20 as shown in FIG. 1. Inverted vehicle assembly 20 may include a longitudinal axis extending between the roof and undercarriage generally along the length thereof from a first end 21c, e.g., the front end, to a second end 21d, e.g., the rear end, of inverted vehicle assembly 20. Inverted vehicle assembly 20 may also include one or more traction devices connected to the undercarriage of the chassis portion.

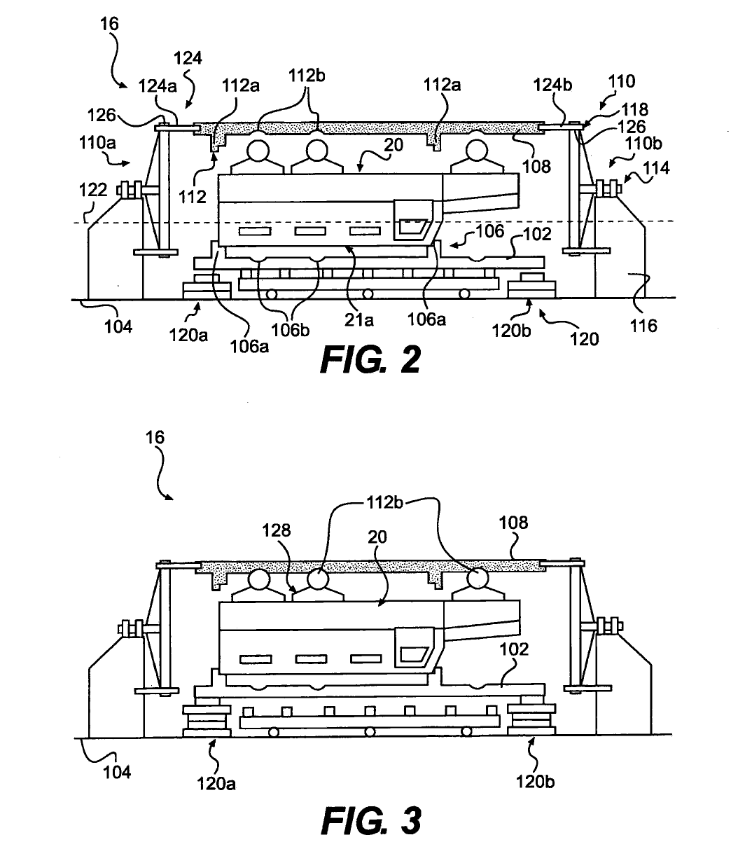

Inverting station 16 may be configured to receive inverted vehicle assembly 20 from station 14 and may include rotating inverted vehicle assembly 20 from an inverted position to an upright position thereby establishing a partially assembled vehicle oriented in an upright position 22, hereinafter referred to as upright vehicle assembly 22. Inverted vehicle assembly 20 and upright vehicle assembly 22 are the same vehicle assembly merely in different orientations. For explanative purposes, however, the two orientations are referenced with different element names and different reference numerals. Station 16 may also be configured to direct upright vehicle assembly 22 toward second assembling station 18. It is contemplated that station 16 may be configured as any relative station of process 10, including, for example, the last station. Station 16 will be further explained below with reference to FIGS. 2-7.

Upright vehicle assembly 22 may include a chassis portion having first side 21a thereof configured to be at least a portion of the roof of a fully assembled vehicle (not shown) and second side 21b thereof, substantially opposite the first side, configured to be at least a portion of the undercarriage of a fully assembled vehicle (not shown). Upright vehicle assembly 22 may be supported with respect to a surface, such as the ground, on second side 21b, e.g., the undercarriage, such that the undercarriage is configured as the “bottom” of upright vehicle assembly 22 and first side 21a, e.g., the roof, is configured as the “top” of upright vehicle assembly 20 as shown in FIG. 1.

Station 18 may be configured to receive upright vehicle assembly 22 from station 16 and may include attaching and/or assembling one or more additional components or sub-assemblies thereto. Station 18 may include welding, bolting, snap-fitting, arranging, and/or any other assembling task known in the art and may include initially pre-assembling one or more subcomponents and subsequently connecting the preassembled subcomponents onto upright vehicle assembly 22. Station 18 may or may not be configured as the last station of manufacturing process 10.

FIGS. 2-7 illustrate various exemplary arrangements of the apparatus associated with station 16 throughout the operation of station 16 to rotate a vehicle assembly. It is contemplated that each of the manipulations of the apparatus of station 16 described below with reference to the operation of station 16 may be performed manually or automatically, with or without additional equipment. The same reference numerals are used throughout FIGS. 2-7 to indicate the same apparatus.

Station 16 may include first frame element 102 configured to initially support inverted vehicle assembly 20 relative to a surface 104, e.g., the ground (as illustrated in FIG. 2). First frame element 102 may made from one or more structural elements, made from any suitable material, such as steel, and may include a substantially rectangular shape (as shown in view A-A in FIG. 5) having a longitudinal direction substantially extending along a longitudinal direction of inverted vehicle assembly 20. First frame element 102 may include a plurality of position indicators 106 including a first subset 106a configured to attach and/or connect first side 21a of inverted vehicle assembly 20 to first frame element 102 and a second subset 106b configured to attach and/or connect second side 21b of inverted vehicle 20 to first frame element 102.

Position indicators 106 may include any type of contacting device capable of interacting with first and second sides 21a, 21b of inverted vehicle assembly 20. For example, position indicators 106 may include brackets, supports, sockets, pins, angles, grooves, depressions, mechanical stops, and/or any other device known in the art. Position indicators 106 may or may not be configured to provide an interlocking attachment and may or may not be configured to provide a frictional engagement.

Station 16 may also include a second frame element 108. Second frame element 108 may be substantially similar to first frame element and may similarly include a plurality of position indicators 112 having a first subset 112a configured to attach and/or connect first side 21a of inverted vehicle assembly 20 to second frame element 108 and a second subset 112b configured to attach and/or connect second side 21b of inverted vehicle 20 to second frame element 108. First and second frame elements 102, 108 are two of a plurality of frame elements, and each one may be substantially the same as the others. For explanative purposes however, the two frame elements are referenced with different element names and different reference numerals. The manner in which first and second frame elements 102, 108 respectively interact and support inverted vehicle assembly 20 as well as with upright vehicle assembly 22 will be explained below with reference to the operation of station 16 and FIGS. 2-7.

First and second frame elements 102, 108 may each be configured to selectively connect with turning apparatus 110. Turning apparatus 110 may include first and second turning apparatus, 110a, 110b which may each include a turnstock 114 supported relative to surface 104 via a base 116 and configured to rotate with respect thereto. First and second turning apparatus 110 may also include an engagement frame 118 operatively connected to turnstock 114 and configured to selectively engage first and second frame elements 102, 108. Turnstock 114 may include any conventional turnstock mechanism configured to rotate an output shaft with respect to base 116. It is contemplated that only one of first and second turning apparatus 110a, 110b may include a turnstock 114, e.g., an active drive shaft, and the other one of first and second turning apparatus 110a, 110b may include a passive shaft. The interaction of turning apparatus 110 with first and second frame elements 102, 108 as well as with inverted and upright vehicle assemblies 20, 22 will be explained below with reference to the operation of station 16 and FIGS. 2-7.

Station 16 may also include one or more lifting jacks 120 which may include any conventional type of lifting jack such as, for example, hydraulic jacks, pneumatic jacks, and/or mechanical jacks and may, for example, include first and second lifting jacks 120a, 120b. The interaction and operation of lifting jacks 120 with first and second frame elements 102, 108 as well as inverted and upright vehicle assemblies 20, 22 will be explained below with reference to the operation of station 16 and FIGS. 2-7.

FIG. 2 illustrates a first exemplary arrangement of station 16 showing inverted vehicle assembly 20 received within station 16. Inverted vehicle assembly 20 may include a longitudinal axis 122 extending therethrough and may be positioned between first and second turning apparatus 110a, 110b such that longitudinal axis 122 extends through first and second turning apparatus 110a, 110b. Inverted vehicle assembly 20 may be supported relative to surface 104 via first frame element 102 and any suitable mechanism such as, for example, a cart, trolley, and/or conveyor mechanism (not referenced) having wheels, casters, or other traction elements configured to permit first frame element 102 and inverted vehicle assembly 20 to be maneuvered within station 16, relative to surface 104, and/or transported between stations 14 and 16. Inverted vehicle assembly 20 may engage first frame element 102 via the first subset 106a of position indicators 106. It is contemplated that first frame element 102 may be received in station 16 according to any orientation relative to turning apparatus 110 and may be subsequently maneuvered within station 16 to the position illustrated in FIG. 2.

As illustrated in FIG. 2, second frame element 108 may be initially connected to each of first and second turning apparatus 110a, 110b via pins 124. Pins 124 may include a pair of pins 124a (only one of which is illustrated) configured to connect first turning apparatus 110a to a first end of second frame element 108. Pins 124 may also include a pair of pins 124b (only one of which is illustrated) configured to connect second turning apparatus 110b to a second end of second frame element 108. Each of pins 124 may be slidably received within a bores 126 located within respective engagement frames 118 of first and second turning apparatus 110a, 110b and may be configured to interact with complementary slots within second frame element 108. It is contemplated that pins 124 may interact with second frame element 108 via an interlocking and/or frictional engagement.

FIG. 3 illustrates second exemplary arrangement of station 16 showing inverted vehicle assembly 20 and first frame element 102 displaced, e.g., lifted, relative to surface 104. Lifting jacks 120 may selectively engage first frame element 102 and lift first frame element 102 relative to surface 104 to raise inverted vehicle assembly 20 to engage second frame element 108. Inverted vehicle assembly 20 may engage second frame element 108 via the second subset 112b of position indicators 112. As such, first frame element 102 may disengage from the cart, trolley, and/or conveyor mechanism and may be temporarily supported along with inverted vehicle assembly 20 via lifting jacks 120.

Inverted vehicle assembly 20 may include one or more spring elements 128 which may form a portion of a traction mechanism of a fully assembled vehicle. Each spring element may include a spring-type shock absorber, e.g., a leaf or coil spring, connected to an axle and may be configured as part of a suspension component of a fully assembled vehicle. Spring element 128 may also be connected to the vehicle chassis of inverted vehicle assembly 20 within first assembling station 14. As lifting jacks 120 displace first frame element 102 and inverted vehicle assembly 20 relative to surface 104, spring elements 128 may be compressed against second frame element 108 as a function of second frame element 108 resisting relative movement of inverted vehicle assembly 20 and first frame element 102 relative to surface 104. It is contemplated that spring elements 128 may be partially or fully compressed against second frame element 108 and that second frame element 108 may be held relatively fixed with respect to surface 104 via turning apparatus 110. As such, lifting jacks 120 may establish a pre-load within spring elements 128. It is contemplated that first and second frame elements 102, 108 may alternatively and/or additionally include spring members therein configured to be partially compressed and establish a pre-load as lifting jacks 120 raise frame element 102 and inverted vehicle assembly 20 to interact with fixed second frame element 108. It is also contemplated that such spring members may be disposed respectively between inverted vehicle assembly 20 and pins 124 and/or between vehicle assembly 20 and pins 130.

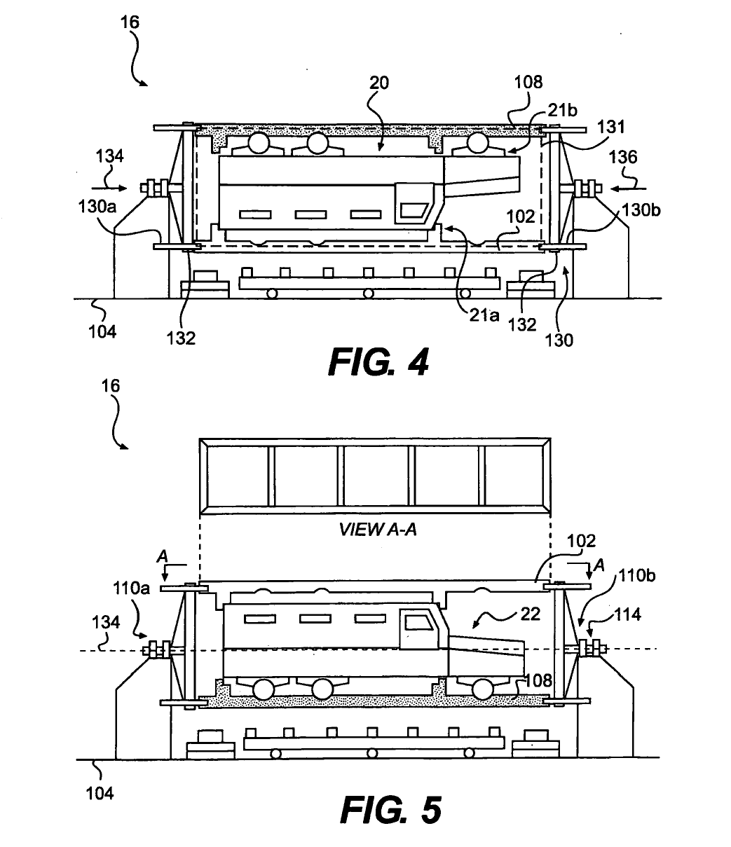

FIG. 4 illustrates a third exemplary arrangement of station 16 showing turning apparatus 110 selectively connected to second frame element 108 as well as to first frame element 102. First frame element 102 may be selectively connected to first and second turning apparatus 110a, 110b via pins 130. Similar to pins 124, pins 130 may include a pair of pins 130a (only one of which is illustrated) configured to connect first turning apparatus 110a to a first end of first frame element 102. Pins 130 may also include a pair of pins 130b (only one of which is illustrated) configured to connect second turning apparatus 110b to a second end of first frame element 102. Each of pins 130 may be slidably received within a bores 132 located within respective engagement frames 118 of first and second turning apparatus 110a, 110b. It is contemplated that pins 130 may interact with first frame element 102 via an interlocking and/or frictional engagement. The relative offset between pins 130 and pins 124 may be configured to substantially retain the pre-load established by lifting jacks 120 within spring elements 128 by maintaining the spacing between first and second frame elements 102, 108 after lifting jacks 120 are disengaged from first frame element 102.

First and second turning apparatus 110a, 110b may be configured to move relative to surface 104 in a direction substantially aligned with longitudinal axis 122 to selectively connect to second frame element 108. For example, first turning apparatus 110a may be configured to move in a direction 134 toward inverted vehicle assembly 20 and second turning apparatus 110b may be configured to move in a direction 136 toward inverted vehicle assembly 20. It is contemplated that turning apparatus 110 may selectively engage and disengage first and second frame elements 102, 108 via any combination of movement of first and second turning apparatus 110a, 110b and/or pins 124, 130. It is also contemplated that turning apparatus 110 may be operatively connected to surface 104 in any suitable manner to facilitate fixing second frame element 108 with respect to surface 104 and engaging first frame element 102 such as, for example, casters, wheels, rails, and/or any other conventional apparatus.

Lifting jacks 120 may be disengaged from first frame element 102 after turning apparatus 110 is connected to first frame element 102 via pins 130. As such, inverted vehicle assembly 20 may be operatively supported relative to surface 104 between first and second frame elements 102, 108 via turning apparatus 110. First and second frame elements 102, 108 may generally define a spatial envelope 131 therebetween configured to support inverted vehicle assembly 20 therein. The envelope defined between first and second frame elements 102, 108 may have a longitudinal dimension and axis substantially aligned with the longitudinal dimensions of first and second frame elements 102, 108 as well as longitudinal axis 122. Although described herein with reference to inverted vehicle assembly 20, it is contemplated that the envelope defined between first and second frame elements 102, 108 may be configured to relatively support any type of equipment relative to surface 104.

Accordingly, as illustrated in FIG. 4, first frame element 102 may be configured to engage inverted vehicle assembly 20 on first side 21a and may be disposed between inverted vehicle assembly 20 and surface 104. Second frame element 108 may be configured to engage inverted vehicle assembly 20 on second side 21b, substantially opposite first side 21a of inverted vehicle assembly 20. As such, inverted vehicle assembly 20 may be disposed substantially between first and second frame elements 102, 108.

FIG. 5 illustrates a fourth exemplary arrangement of station 16 showing upright vehicle assembly 22. It is understood that upright vehicle assembly 22 is the same vehicle assembly as inverted vehicle assembly 20 and is designated with a different reference numeral for explanative purposes only.

Turning apparatus 110 may be configured to selectively rotate first and second frame elements 102, 108 along with inverted vehicle assembly 20 approximately 180 degrees about a longitudinal axis 134 substantially intersecting the rotation axis of each turnstock 114 of first and second turning apparatus 110a, 110b. Longitudinal axis 134 may or may not be offset from longitudinal axis 122 (see FIG. 2) and may or may not be aligned with the center of gravity of inverted vehicle assembly 20. First and second frame elements 102, 108, along with inverted vehicle assembly 20, may collectively establish a combined center of gravity, and longitudinal axis 134 may or may not be aligned with the combined center of gravity. It is contemplated that turning apparatus 110 may be configured to rotate a combined weight of first frame element 102, second frame element 108, and inverted vehicle assembly 20 in excess of 20,000 pounds.

After first and second frame elements 102, 108 as well as inverted vehicle assembly 20 are rotated, thereby establishing upright vehicle assembly 22, the position of first and second frame elements 102, 108 may be substantially opposite their respective positions before rotating. As such, second frame element 108 may be disposed between upright vehicle assembly 22 and surface 104, upright vehicle assembly 22 may be disposed between second and first frame elements 108, 102, and first frame element 102 may be disposed on a side of upright vehicle assembly 22 substantially opposite second frame element 108.

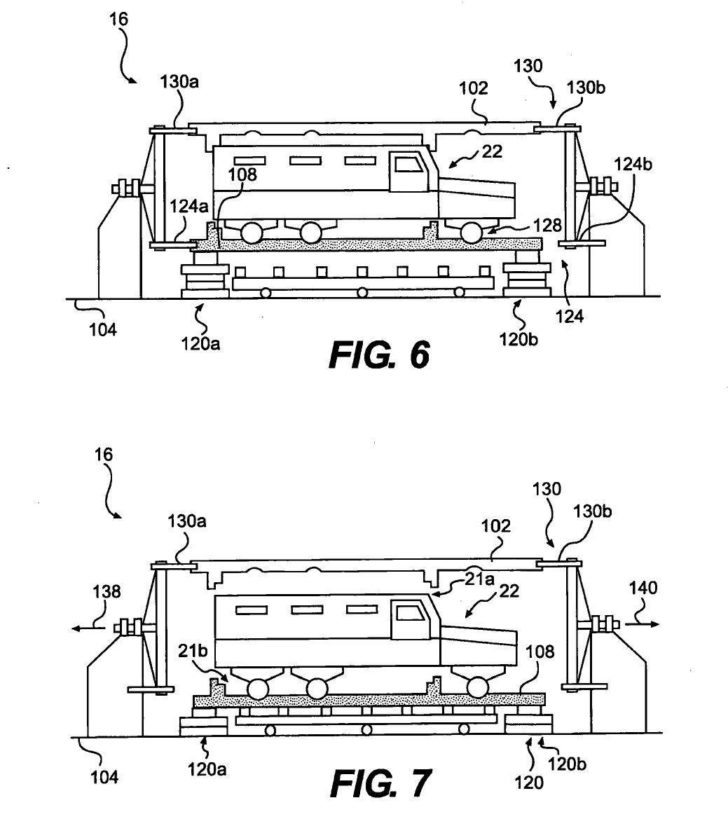

FIG. 6 illustrates a fifth exemplary arrangement of station 16 showing lifting jacks 120 selectively engaging second frame element 108. As such, upright vehicle assembly 22 may be operatively supported relative to surface 104 via lifting jacks 120 and second frame element 108 as well as via turning apparatus 110. Lifting jacks 120 may be displaced relative to surface 104 to engage second frame element 108 and counter the pre-load on spring elements 128 maintained by first and second turning apparatus 110a, 110b. As such, respective pairs of pins 124a and/or 124b may be selectively disengaged, e.g., by sliding in bores 126, from second frame element 108 and first and second lifting jacks 120a, 120b may maintain the pre-load on spring elements 128 against first frame element 102.

FIG. 7 illustrates a sixth exemplary arrangement of station 16 showing turning apparatus 110 selectively disconnected from second frame element 108 and upright vehicle assembly 22 disengaged from first frame element 102. First frame element 102 may remain selectively connected to first and second turning apparatus 110a, 110b via respective pairs of pins 130a and/or 130b. Turning apparatus 110 may be selectively disengaged from second frame element 108 by respective movement thereof in the longitudinal direction relative to surface 104. For example, first turning apparatus 110a may be configured to move in a direction 138 away from upright vehicle assembly 22 and second turning apparatus 110b may be configured to move in a direction 140 away from upright vehicle assembly 22. It is contemplated that movement of turning apparatus 110 may also facilitate maneuvering inverted and/or upright vehicle assemblies 20, 22 within station 16.

Lifting jacks 120 may be configured to displace, e.g., lower, second frame element 108 and upright vehicle assembly 22 relative to surface 104 to disengage upright vehicle assembly 22 from first frame element 102 and lower second frame element 108 and upright vehicle assembly 22 toward surface 104. Upright vehicle assembly 22 may be supported relative to surface 104 via second frame element 108 and any suitable mechanism such as, for example, a cart, trolley, and/or conveyor mechanism (not referenced) having wheels, casters, or other traction elements configured to permit second frame element 108 and upright vehicle assembly 22 to be maneuvered within station 16 relative to surface 104 and/or transported between stations 16 and 18. It is contemplated that second frame element 108 may or may not be supported relative to surface 104 via the same cart, trolley, and/or conveyor that supported first frame element 102 relative to surface 104. It is also contemplated that second frame element 108 may be maneuvered relative to turning apparatus 110 according to any orientation to facilitate delivery to station 18.

As illustrated in FIG. 7, first frame element 102 may remain connected to each of first and second turning apparatus 110a, 110b via pins 130. As such, when upright vehicle assembly 22 is transported to station 18 via second frame element 108, station 16 will be configured to receive another inverted vehicle assembly 20. Because first and second frame elements 102, 108 are substantially the same and each include position indicators 106, 112 (as illustrated in FIG. 2) to operatively engage both first and second sides 21a, 21b of upright vehicle assembly 22, e.g., the roof and undercarriage portions of a vehicle assembly, first frame element 102 (as illustrated in FIG. 7) may be configured as second frame element 108 (as illustrated in FIG. 2). Accordingly, station 16 may be configured to receive and manipulate another inverted vehicle assembly 20 to establish another upright vehicle assembly 22.

Thus, as additional vehicle assemblies pass through station 16 to be rotated from an inverted position to an upright position, an inverted vehicle assembly, e.g., inverted vehicle assembly 20, may enter station 16 on an new frame element corresponding to first frame element 102, be rotated with the new frame element and an existing frame element, corresponding to second frame element 108, and an upright vehicle assembly, e.g., upright vehicle assembly 22, may leave station 16 on the existing frame element. The new frame element may remain within station 16 and become the existing frame element for the next vehicle assembly that is to be rotated within station 16, as one skilled in the art would understand. This process of exchanging frame elements as additional vehicle assemblies are rotated from an inverted position to an upright position may substantially repeat for each rotation of a vehicle assembly within station 16.

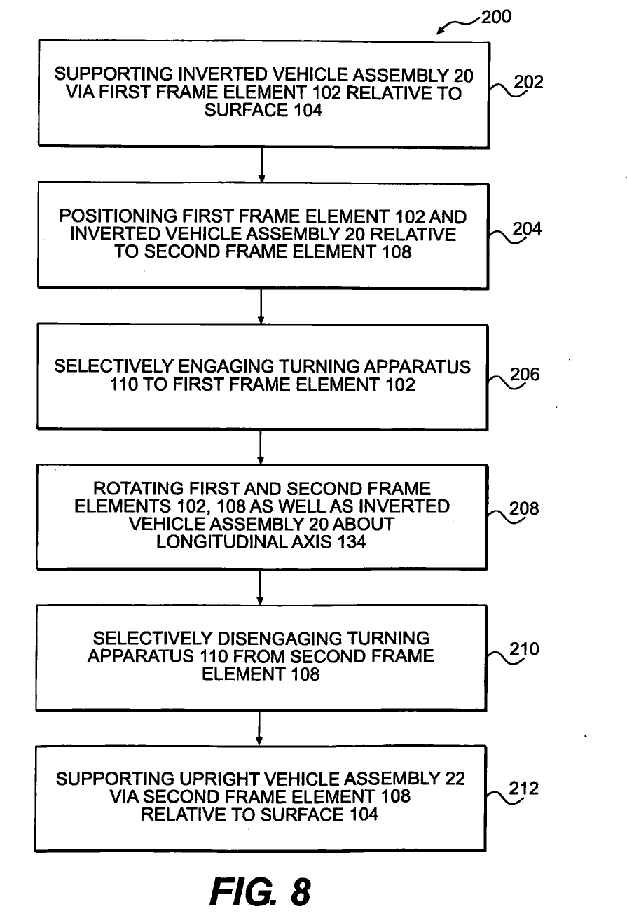

FIG. 8 illustrates an exemplary method 200 of inverting a vehicle assembly. Method 200 may include supporting inverted vehicle assembly 20 via first frame element 102 relative to surface 104, step 202. For example, step 202 may include supporting and transporting inverted vehicle assembly 20 between station 14 and station 16 as shown in FIG. 1 as well as supporting inverted vehicle assembly 20 within station 16.

Method 200 may also include positioning first frame element 102 and inverted vehicle assembly 20 relative to second frame element 108, step 204. For example, step 204 may include maneuvering first frame element 102 and inverted vehicle assembly 20 relative to second frame 108, turning apparatus 110, and lifting jacks 120 within station 16 as described above with reference to FIG. 2. Additionally, step 204 may include engaging lifting jacks 120 with first frame element 102 and lifting first frame element 102 and inverted vehicle assembly 20 relative to surface 104 to engage inverted vehicle assembly 20 with second frame element 108 and compress spring elements 128 as described above with reference to FIG. 3.

Method 200 may also include selectively engaging turning apparatus 110 with first frame element 102, step 206. For example, step 206 may include selectively moving first and second turning apparatus 110a, 110b toward inverted vehicle assembly 20 and engaging pins 130 at respective ends of first frame element 102 as described above with reference to FIG. 4.

Method 200 may also include rotating first and second frame elements 102, 108 as well as inverted vehicle assembly 20 about longitudinal axis 134, step 208. For example, step 208 may include one or both of first and second turning apparatus 110a, 110b rotating inverted vehicle assembly 20 approximately 180 degrees to establish upright vehicle assembly 22, as described above with reference to FIG. 5.

Method 200 may also include selectively disengaging turning apparatus 110 from second frame element 108, step 210. For example, step 210 may include selectively engaging lifting jacks 120 with second frame element 108 to support upright vehicle assembly 22 and second frame element 108, as described above with reference to FIG. 6. Additionally, step 210 may include selectively moving first and second turning apparatus 110a, 110b away from upright vehicle assembly 22 and disengaging pins 124 from respective ends of second frame element 108, as described above with reference to FIG. 7.

Method 200 may also include supporting upright vehicle assembly 22 with second frame element 108 relative to surface 104, step 212. For example, step 212 may include supporting inverted vehicle assembly 20 within station 16 and supporting and transporting upright vehicle assembly 22 between station 16 and station 18 as shown in FIG. 1.

It will be apparent to those skilled in the art that various modifications and variations can be made to the disclosed method and apparatus for inverting a vehicle assembly. Other embodiments will be apparent to those skilled in the art from consideration of the specification and practice of the disclosed method and apparatus. It is intended that the specification and examples be considered as exemplary only, with a true scope being indicated by the following claims and their equivalents.

1.-32. (canceled)

33. Method of inverting a vehicle assembly, comprising:
initially supporting the vehicle assembly with a first frame element relative to a surface;
positioning the first frame element and the vehicle assembly relative a second frame element, such that at least a portion of the vehicle assembly is disposed between the first and second frame elements;
selectively engaging at least one turning apparatus with the first frame element;
rotating the first frame element, the vehicle assembly, and the second frame element about a longitudinal axis extending through the vehicle assembly via the at least one turning apparatus from a first position, wherein the first frame element is disposed between the surface and the vehicle assembly, to a second position, wherein the second frame element is disposed between the surface and the vehicle assembly;
selectively disengaging the at least one turning apparatus from the second frame element; and
subsequently supporting the vehicle assembly with the second frame element relative to the surface.

34. The method of claim 33, wherein the at least one turning apparatus is engaged to second frame element during the step of positioning the first frame element.

35. The method of claim 33, further including maintaining the selective engagement of the at least one turning apparatus to the first frame element during the step of selectively disengaging the at least one turning apparatus from the second frame element.

36. The method of claim 33, further including lifting the vehicle assembly and the first frame element with at least one lifting jack relative to the first surface before selectively engaging the at least one turning apparatus with the first frame element.

37. The method of claim 36, wherein lifting the vehicle assembly and the first frame element includes at least partially compressing a spring.

38. The method of claim 37, further including maintaining a preload on the at least one partially compressed spring by selectively engaging the at least one turning apparatus to the first frame element.

39. The method of claim 33, further including supporting the vehicle assembly between first and second stations of a vehicle assembly line via the first frame element and supporting the vehicle assembly between the second station and a third station of the vehicle assembly line via the second frame element, the second station including the at least one turning apparatus.

40. The method of claim 33, wherein supporting the vehicle assembly via the first frame and supporting the vehicle assembly via the second frame each includes supporting the vehicle assembly via substantially similarly shaped frame elements.

41. The method of claim 33, wherein the vehicle assembly includes a shock absorber for a traction device of the vehicle assembly and the method further includes selectively engaging the shock absorber with the second frame element before rotating the vehicle assembly, the first frame element, and the second frame element.

42. The method of claim 33, wherein the first and second frame elements each include a plurality of position indicators including a first subset and a second subset and the method further includes engaging a first side of the vehicle assembly via the first subset of position indicators and engaging a second side of the vehicle assembly via the second subset of position indicators.

43. The method of claim 42, wherein the first side of the vehicle assembly is configured to form at least part of a roof of a fully assembled vehicle and the second side of the vehicle assembly is configured form at least a part of the undercarriage of a fully assembled vehicle.

44. The method of claim 33, wherein selectively engaging the at least one turning apparatus with the first frame element includes moving the at least one turning apparatus toward the first frame element in a direction aligned with the longitudinal axis.

45. The method of claim 33, wherein the vehicle assembly, the first frame element, and the second frame element define a rotatable assembly having a center of gravity and the method further includes rotating the rotatable assembly about an axis offset from the center of gravity.

46. The method of claim 33, wherein the at least one turning apparatus includes a first turning apparatus disposed at a first end of the first frame element and second turning apparatus disposed at a second end of the first frame element, the second end substantially opposite the first end and wherein selectively engaging the at least one turning apparatus with the first frame element includes selectively engaging each of the first and second turning apparatus with respective first and second ends of the first frame element.

47. The method of claim 46, wherein rotating the first frame element, the vehicle assembly, and the second frame element about a longitudinal axis includes rotating the first frame element, the vehicle assembly, and the second frame element about an axis that extends through each of the first and second turning apparatus.

48. Method of assembling a vehicle, comprising:
partially assembling the vehicle at a first station of a manufacturing process;
transporting the partially assembled vehicle from the first station to a second station of the manufacturing process on a first frame member configured to support the partially assembled vehicle with respect to the ground;
supporting the partially assembled vehicle at the second station via the first frame member and via a second frame member;
rotating the partially assembled vehicle, the first frame member, and the second frame member about an axis that passes through the partially assembled vehicle; and
transporting the partially assembled vehicle from the second station to a third station of the manufacturing process on the second frame member, the second frame member configured to support the partially assembled vehicle with respect to the ground.

49. The method of claim 48, wherein rotating the partially assembled vehicle and the first and second frame members includes moving the partially assembled vehicle and the first and second frame members from a first position, wherein the partially assembled vehicle is disposed between the first and second frame members and the first frame member is disposed closer to the ground than the second frame member, to a second position, wherein the partially assembled vehicle is disposed between the first and second frame members and the second frame member is disposed closer to the ground than the second frame member.

50. The method of claim 48, further including raising the first frame member and the partially assembled vehicle at the second station to engage the partially assembled vehicle with the second frame member.

51. The method of claim 50, wherein raising the first frame member and the partially assembled vehicle further includes at least partially compressing a spring element.

52. The method of claim 51 wherein at least partially compressing a spring element includes partially compressing a component of the partially assembled vehicle.

53. The method of claim 48, wherein partially assembling a vehicle includes assembling components to partially establish a vehicle chassis and connecting at least one axle to the vehicle frame via a spring element.

54. The method of claim 53, wherein transporting the partially assembled vehicle from the first station to the second station includes supporting the partially assembled vehicle on the first frame member such that the first frame member is disposed between the ground and the vehicle chassis and the vehicle chassis is disposed between the first frame member and the spring element.

55. The method of claim 48, wherein the first and second frame elements each include a plurality of position indicators including a first subset and a second subset, the method further including engaging a first side of the vehicle assembly via the first subset of position indicators and engaging a second side of the vehicle assembly via the second subset of position indicators.

56. The method of claim 48, wherein:
supporting the partially assembled vehicle from the first station to the second station includes engaging the first frame member with a roof portion of the partially assembled vehicle; and
supporting the partially assembled vehicle from the second station to the third station includes engaging the second frame member with an undercarriage portion of the partially assembled vehicle.

57. The method of claim 48, wherein rotating the partially assembled vehicle and the first and second frame members includes selectively connecting at least one turnstock with the first and second frame members.
